(19) United States
(12) Patent Application Publication
(10) Pub. No.: US 2026/0197731 A1
(43) Pub. Date: Jul. 9, 2026

(54) METHOD AND APPARATUS OF SUPPORTING QUALITY OF EXPERIENCE (QoE) MEASUREMENT COLLECTION

(71) Applicant: LENOVO (BEIJING) LIMITED, Beijing (CN)

(72) Inventors: Mingzeng Dai, Shanghai (CN); Hyung-Nam Choi, Ottobrunn (DE); Congchi Zhang, Shanghai (CN); Lianhai Wu, Beijing (CN)

(21) Appl. No.: 19/134,356

(22) PCT Filed: Feb. 17, 2023
(86) PCT No.: PCT/CN2023/076802

§ 371 Date: May 30, 2025

(51) Int. Cl. H04W 36/00

(52) U.S. Cl. CPC H04W 36/0094

(57) ABSTRACT

Embodiments of the present application relate to a method and apparatus of supporting quality of experience (QoE) measurement collection. An exemplary method, e.g., performed by UE may include: receiving QoE measurement configuration information for a QoE measurement, wherein, the QoE measurement is configured by a master node (MN) and a reporting leg for QoE measurement report of the QoE measurement is configured to be a secondary cell group (SCG), or the QoE measurement is configured by a secondary node (SN) and a reporting leg for QoE measurement report of the QoE measurement is configured to be a master cell group (MCG) or SCG; and determining operations on the QoE measurement in response to the SCG being determined to be unavailable.

### TECHNICAL FIELD

Embodiments of the present application generally relate to wireless communication technology, especially to a method and apparatus of supporting quality of experience (QoE) measurement collection.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems. However, the wireless communication systems still need to evolve to pursue better service quality, better service experience and lower cost etc.

In 3rd generation partnership project (3GPP) release (Rel)-17, the basic mechanism for NR QoE has been specified. Since NR-dual connectivity (DC) is an important commercial deployment scenario for 5G networks, it is critical to support NR-DC in the NR QoE framework. Therefore, QoE in Rel-18 will support QoE measurement configuration and measurement reporting for NR-DC scenario, as agreed below in RP-213594:
Specify the QoE configuration, and measurement reporting over MN/SN for NR-DC architecture and specify the QoE measurement reporting over the other DC leg in order to maintain the reporting continuity.

Given the above, the industry desires technology to improve QoE measurement collection, especially improving technology of supporting QoE measurement collection for NR-DC scenarios.

### SUMMARY OF THE APPLICATION

An objective of the embodiments of the present application is to provide a technical solution of supporting QoE measurement collection, e.g., a method and apparatus of handling SCG related QoE measurements in the case of SCG being unavailable.

Some embodiments of the present application provide a UE, which includes: a transceiver; and a processor coupled to the transceiver, wherein the processor is configured to: receive QoE measurement configuration information for a QoE measurement, wherein, the QoE measurement is configured by a master node (MN) and a reporting leg for QoE measurement report of the QoE measurement is configured to be a secondary cell group (SCG), or the QoE measurement is configured by a secondary node (SN) and a reporting leg for QoE measurement report of the QoE measurement is configured to be a master cell group (MCG) or SCG; and determine operations on the QoE measurement in response to the SCG being determined to be unavailable.

In some embodiments of the present application, the processor is configured to: determine that the SCG is unavailable in response to SCG failure occurring; and switch the reporting leg from the SCG to be a predefined MCG or a configured MCG, wherein the configured MCG is configured in the QoE measurement configuration information or in other configuration information for the QoE measurement.

According to some embodiments of the present application, in response to SCG failure occurring while the QoE measurement report of the QoE measurement being available, the processor is configured to: transmit, to the MN, information indicating that the QoE measurement report of the QoE measurement is available when SCG failure occurs; and receive the other configuration information for the QoE measurement from the MN.

According to some embodiments of the present application, in response to SCG failure occurring while the QoE measurement report of the QoE measurement being available, the processor is configured to: determine whether signalling radio bearer (SRB) 4 for reporting the QoE measurement report is configured or not; and in the case that SRB4 is configured, switch the reporting leg to be the MCG from the SCG, wherein, the MCG is predefined or configured in the QoE measurement configuration information; or in the case that no SRB4 is configured, transmit, to the MN, information indicating that QoE measurement report is available when SCG failure occurs; and receive the other configuration information for the QoB measurement from the MN.

In some embodiments of the present application, the processor is configured to: determine that the SCG is unavailable in response to SCG failure occurring; and until receiving information indicating another reporting leg from the MN, suspend reporting the QoE measurement report; and buffer the QoE measurement report in the case that the QoE measurement report is available in radio resource control (RRC) layer.

In some embodiments of the present application, in the case that the QoE measurement is configured by the SN, the processor is configured to: determine that the SCG is unavailable in response to SCG failure occurring; release the QoE measurement; and discard the QoE measurement report in the case that the QoE measurement report is available in RRC layer.

In some embodiments of the present application, in the case that the QoE measurement is configured by the SN, the processor is configured to: determine that the SCG is unavailable in response to SCG failure occurring; pause the QoE measurement; and suspend reporting the QoE measurement report.

According to some embodiments of the present application, the processor is configured to: receive information indicating another reporting leg for reporting the QoE measurement report; resume the QoE measurement; and resume reporting the QoE measurement report via the another reporting leg.

According to some embodiments of the present application, the processor is configured to: determine that SCG failure occurs in response to at least one of the following: radio link failure for the SCG; beam failure of primary secondary cell (PSCell) while the SCG is deactivated; reconfiguration with sync failure of the SCG; SCG configuration failure; or integrity check failure indication from SCG lower layers concerning SRB3.

In some embodiments of the present application, in the case that the QoE measurement is configured by the SN, the processor is configured to: determine that the SCG is unavailable in response to that the SCG is released; determine whether the QoE measurement will be kept or released based on an indication from the MN; and in the case that the indication indicates that the QoE measurement will be kept, continue the QoE measurement by treating the QoE measurement as MN configured QoE measurement after the SCG is released and changing the reporting leg; or in the case that the indication indicates that the QoE measurement will be released, release the QoE measurement and discard the QoE measurement report.

According to some embodiments of the present application, in the case that the indication indicates that the QoE measurement will be kept, the processor is configured to: receive another indication indicating reporting leg is changed; and change the reporting leg according to the other indication.

In some embodiments of the present application, the QoE measurement is configured by the SN, and the processor is configured to: determine that the SCG is unavailable in response to the SCG being deactivated; and switch the reporting leg to be a predefined MCG or a configured MCG from the SCG, wherein the configured MCG is configured in the QoE measurement configuration information or in other configuration information.

According to some embodiments of the present application, in the case that the configured MCG is configured in the other configuration information, the processor is configured to: transmit, to the MN, information indicating that QoE measurement report is available when the SCG is deactivated in response to SCG deactivation while the QoE measurement report for the QoE measurement being available; and receive the other configuration information from the MN.

According to some embodiments of the present application, in response to the SCG being deactivated while the QoE measurement report for the QoE measurement being available, the processor is configured to: determine whether SRB4 for reporting the QoE measurement report is configured or not; and in the case that SRB4 is configured, switch the reporting leg to be the MCG from the SCG, wherein, the MCG is predefined or configured in the QoE measurement configuration information; or in the case that no SRB4 is configured, transmit, to the MN, information indicating that QoE measurement report is available when the SCG is deactivated; and receive the other configuration information indicating the MCG from the MN.

According to some embodiments of the present application, the processor is configured to: switch the reporting leg to the SCG in response to the SCG being activated.

In some embodiments of the present application, the QoE measurement is configured by the SN, and the processor is configured to: determine that the SCG is unavailable in response to the SCG being deactivated; and until the SCG is activated, suspend reporting the QoE measurement report; and buffer the QoE measurement report in the case that the QoE measurement report is available in RRC layer.

In some embodiments of the present application, the QoE measurement is configured by the SN, and the processor is configured to: determine that the SCG is unavailable in response to the SCG being deactivated; release the QoE measurement; and discard the QoE measurement report in the case that the QoE measurement report is available in RRC layer.

According to some embodiments of the present application, the processor is configured to: transmit, from an access stratum (AS) layer to a layer upper than the AS layer, information indicating that the QoE measurement is to be released; and discard any stored segments of segmented RRC messages related with the SCG by the AS layer.

According to some embodiments of the present application, the QoE measurement is configured by the SN, and the processor is configured to: determine that the SCG is unavailable in response to the SCG being deactivated; and pause the QoE measurement.

According to some embodiments of the present application, the processor is configured to: receive, from an AS layer by a layer upper than the AS layer, an SCG failure indication; and pause the QoE measurement by the layer upper than the AS layer.

According to some embodiments of the present application, the processor is configured to: receive, from an AS layer by a layer upper than the AS layer, an SCG deactivation indication; and pause the QoE measurement by the layer upper than the AS layer.

In some scenarios, the processor is configured to: receive, from the AS layer, by the layer upper than the AS layer, information indicating that the QoE measurement is configured by SN.

According to some embodiments of the present application, the processor is configured to: receive, from an AS layer by a layer upper than the AS layer, information indicating that the QoE measurement is requested to be paused and a RRC identifier identifying the QoE measurement; and pause the QoE measurement by the layer upper than the AS layer.

According to some embodiments of the present application, the processor is configured to: suspend reporting the QoE measurement report via the SCG in response to a pause indication from the MN; and resume reporting the QoE measurement report via the SCG in response to a resume indication from the MN.

In some scenarios, the processor is configured to: indicate, by an AS layer to a layer upper than the AS layer to resume the QoE measurement and resume reporting the QoE measurement report.

Some other embodiments of the present application provide a radio access network (RAN) node, e.g., an MN, which includes: a transceiver; and a processor coupled to the transceiver, wherein the processor is configured to: receive first QoE measurement configuration information for a QoE measurement configured by a source SN for a UE from the SN; transmit the first QoE measurement configuration information to a target SN; and receive delta configuration information of the first QoE measurement configuration information from the target SN.

In some embodiments of the present application, the first QoE measurement configuration information is received from the SN in an SN modification request acknowledge message or an SN change required message.

In some embodiments of the present application, the processor is configured to transmit second QoE measurement configuration information configured by the RAN node to the target SN.

In some embodiments of the present application, the processor is configured to transmit the delta configuration information to the UE.

Some yet other embodiments of the present application also provide a RAN node, e.g., a target SN, which includes: a transceiver; and a processor coupled to the transceiver, wherein the processor is configured to: receive first QoE measurement configuration information for a QoE measurement configured by an SN from an MN; generate delta configuration information of the first QoE measurement configuration information; and transmit the delta configuration information of the first QoE measurement configuration information to the MN.

In some embodiments of the present application, the processor is configured to receive second QoE measurement configuration information configured by the MN from the MN.

Given the above, embodiments of the present application provide a technical solution of supporting QoE measurement collection, which can handle SCG related QoE measurements in the case of SCG(s) event occurring in NR-DC scenarios, and improve reporting continuity of QoE measurement. Accordingly, embodiments of the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 is a flow chart of an exemplary procedure of supporting QoE measurement collection in the case of SCG failure occurrence according to some embodiments of the present application.

FIG. 3 is a flow chart of an exemplary procedure of supporting QoE measurement collection in the case of SCG being released according to some embodiments of the present application.

FIG. 4 is a flow chart of an exemplary procedure of supporting QoE measurement collection in the case of SCG change according to some embodiments of the present application.

FIG. 5 illustrates a block diagram of an apparatus of supporting QoE measurement collection according to some embodiments of the present application.

FIG. 6 illustrates a block diagram of an apparatus of supporting QoE measurement reporting according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, and so on. It is contemplated that along with the developments of network architectures and new service scenarios, all embodiments in the present application are also applicable to similar technical problems. Moreover, the terminologies recited in the present application may change, which should not affect the principle of the present application.

In a NR-DC scenario, a UE with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as an MN and the other node may act as an SN. The MN and SN are connected via a network interface, e.g., Xn interface as specified in 3GPP standard documents, and at least the MN is connected to the core network (CN).

For example, FIG. 1 illustrates a schematic diagram of a wireless communication system 100 in accordance with some embodiments of the present application.

As shown in FIG. 1, the wireless communication system 100 may be a dual connectivity system 100 includes at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, the UE 101 may connect to the MN 102 and the SN 103 via an interface, for example, Uu interface as specified in 3GPP standard documents. The MN 102 and the SN 103 may be connected with each other via a network interface, for example, Xn interface as specified in 3GPP standard documents. The MN 102 may be connected to the core network via a network interface (not shown in FIG. 1), for example, NG interface as specified in 3GPP standard documents. The UE 101 may be configured to utilize resources provided by the MN 102 and the SN 103 to perform data transmission.

In some embodiments of the present application, the UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, the UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, the UE 101 may include wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The MN 102 refers to a RAN node that provides a control plane connection to the core network. In an embodiment of the present application, in the E-UTRA-NR DC (EN-DC) scenario, the MN 102 may be an eNB. In another embodiment of the present application, in the next generation E-UTRA-NR DC (NGEN-DC) scenario, the MN 102 may be a next generation (ng)-eNB. In yet another embodiment of the present application, in the NR-DC scenario or the NR-E-UTRA DC (NE-DC) scenario, the MN 102 may be a gNB. An MN 102 may also be referred to as a master-NG-RAN (M-NG-RAN) node in some embodiments of the present application.

An MN leg may be referred to as an MCG. The MCG may refer to a group of serving cells associated with the MN 102, and include a primary cell (PCell) and optionally one or more secondary cells (SCells). The PCell may provide a control plane connection to the UE 101.

The SN 103 may refer to a radio access network node without control plane connection to the core network but providing additional resources to the UE 101. In some embodiments of the present application, in the EN-DC scenario, the SN 103 may be an en-gNB. In some other embodiments of the present application, in the NE-DC scenario, the SN 103 may be an ng-eNB. In yet another embodiment of the present application, in the NR-DC scenario or the NGEN-DC scenario, the SN 103 may be a gNB. An SN 103 may also be referred to as a secondary-NG-RAN (S-NG-RAN) node in some embodiments of the present application.

An SN leg may be referred to as an SCG. The SCG may refer to a group of serving cells associated with the SN, and include a PSCell and optionally one or more SCells. The PCell of the MCG and the PSCell of the SCG may also be referred to as a special cell (SpCell).

In addition, regarding QoE measurement collection (QMC, also referred to as “QoE measurement”) activation and reporting, TS38.300 specifies the following:
“The feature is activated in the NG-RAN either by direct configuration from the OAM system (management-based activation), or by signalling from the OAM via the Core Network (signalling-based activation), containing UE-associated QoE configuration. One or more QoE measurement collection jobs can be activated at a UE per service type, and each QoE measurement configuration is uniquely identified by a QoE Reference.
For signalling-based QoE measurements, the OAM initiates the QoE measurement activation for a specific UE via the Core Network, and the NG-RAN node receives one or more QoE measurement configurations by means of UE-associated signalling. The QoE measurement configuration for signalling-based activation includes an application layer measurement configuration list and the corresponding information for QoE measurement collection, e.g., QoE Reference, service type, MCE IP Address, Slice Scope, Area Scope, MDT Alignment Information and the indication of available RAN visible QoE metrics. Each application layer measurement configuration is encapsulated in a transparent container. The NG-RAN node forwards the corresponding QoE measurement configuration(s) to the UE in a downlink RRC message containing AppLayerMeasConfig, as specified in TS38.331 [12].
For management-based QoE measurement activation, the OAM sends one or more the QoE measurement configurations to the NG-RAN node. The QoE measurement configuration for management-based activation also includes an application layer measurement configuration list and the corresponding information for QoE measurement collection. Each application layer measurement configuration is encapsulated in a transparent container. The NG-RAN node selects UE(s) that meet the required QoE measurement capability, Area Scope and Slice Scope.
The UE reports QoE measurement results to the NG-RAN node in an uplink RRC message, as specified in TS38.331 [12]. The NG-RAN node transmits the QoE report and the corresponding QoE Reference ID to the MCE.
The QoE measurement collection is handled by application layer measurement configuration and measurement reporting, supported in RRC_CONNECTED state only. Application layer measurement configuration received by the gNB from OAM or CN is encapsulated in a transparent container, which is forwarded to a UE as Application layer configuration in the RRCReconfiguration message (there can be multiple configurations in the same message). Application layer measurement reports received from UE's higher layer are encapsulated in a transparent container and sent to the network in the MeasurementReportAppLayer message, as specified in TS 38.331 [12]. The UE can send multiple application layer measurement reports to the gNB in one MeasurementReportAppLayer message. In order to allow the transmission of application layer measurement reports which exceed the maximum PDCP SDU size, segmentation of the MeasurementReportAppLayer message may be enabled by the gNB. A measConfigAppLayerId conveyed in the RRC signalling is used to identify the application layer measurement configuration and report between the gNB and the UE. The RRC identifier is mapped to the QoE Reference in the gNB. The application layer measurement report is forwarded to OAM together with the QoE Reference. gNB can release one or multiple application layer measurement configurations from the UE in one RRCReconfiguration message at any time. The UE may additionally be configured by the gNB to report when a QoE measurement session starts or stops for a certain application layer measurement configuration.”

Thus, QoE measurement collection in the NG-RAN can be activated by two manners, i.e., management-based activation and signalling-based activation. In the case of management-based activation, the RAN node, e.g., a gNB receives direct configuration from the OAM (or OAM system). In the case of signalling-based activation, the RAN node receives signalling containing UE-associated QoE configuration from the OAM via the CN. QoE measurement may also be called as application layer measurement. The application layer measurement configuration (e.g., QoE measurement configuration) received by the gNB from the OAM or CN is encapsulated in a transparent container in Rel-17, which is forwarded to a UE as application layer configuration in a RRCReconfiguration message. There may be multiple application layer measurement configurations in the same message, each corresponding to an application layer measurement or QoE measurement. Application layer measurement reports received from UE's application layer will be encapsulated in a transparent container and sent to the network in a RRC message, e.g., MeasurementReportAppLayer message. In order to allow the transmission of application layer measurement reports which exceed the maximum (packet data convergence protocol (PDCP) SDU size, segmentation of the MeasurementReportAppLayer message may be enabled by the gNB.

In scenarios of NR-DC, both the MN leg (or MCG) and SN leg (or SCG) can be used for QoE measurement collection. Either the MN or the SN may configure (or transmit, or provide etc.) QoE measurements to a UE in response to management-based activation or signalling-based activation, wherein, the reporting leg(s) for QoE measurement report may be configured as an MCG and/or SCG.

According to RP-213594, the support for QoE measurement configuration and measurement reporting over MN/SN for NR-DC scenario will be settled in Rel-18, and thus a mass of issues need to be solved. For example, when an SCG event (e.g., SCG failure, SCG change, SCG release or SCG deactivation) happens, how to handle the SCG related QoE measurement needs to be solved at least to maintain the reporting continuity, which include but is not limited to: how to handle the available QoE measurement report and on-going QoE measurement by the UE when SCG failure(s) occurs (Issues 1), how to handle SN configured QoE measurement when SCG is deactivated (Issues 2), how to handle SN configured QoE measurement when SCG is released (Issues 3), and how to support QoE measurement during SCG change procedure (Issues 4) etc.

Regarding “SCG related QoE measurement”, it refers to a QoE measurement configured by an SN, or a QoE measurement whose report (or measurement results) is configured to be reported via an SCG. For example, in some cases, an SCG related QoE measurement is a QoE measurement configured by the MN (received from or provided by the MN in the perspective of UE), but the QoE measurement report of the QoE measurement is configured to be an SCG (or SN leg), which means that the UE will send the QoE measurement report to the network by the SCG, e.g., by an MN terminated split SRB (e.g. SRB4) or an SN terminated SRB (e.g. SRB3). In some other cases, an SCG related QoE measurement is a QoE measurement configured by the SN (received from or provided by the SN in the perspective of UE), and the QoE measurement report of the QoE measurement is configured as an MCG (or MN leg) and/or an SCG (or SN leg), which means that the UE will send the QoE measurement report to the network by the MCG or SCG, e.g., either by an SN terminated split SRB or an SN terminated SRB.

At least to solve the above issues on QoE measurement collection, embodiments of the present application provide technical solutions of supporting QoE measurement collection, e.g., a method and apparatus of supporting QoE measurement collection considering SCG event(s) occurrence.

For example, some embodiments of the present application provide a method of supporting QoE measurement collection, which can be performed by a UE or the like. An exemplary method may include: receiving QoE measurement configuration information for an SCG related QoE measurement; and determine operations on the SCG related QoE measurement in response to the SCG being determined to be unavailable. Exemplary cases of the SCG being determined to be unavailable may be due to SCG failure occurrence, SCG release or SCG deactivation etc. For example, the UE may determine that the SCG is unavailable in response to SCG failure occurring, or determine that the SCG is unavailable in response to SCG release, or determine that the SCG is unavailable in response to SCG deactivation.

Some other embodiments of the present application provide another method of supporting QoE measurement collection, which may be performed in a RAN node during SN (or SCG) change procedure, e.g., an MN or the like. An exemplary method may include: receiving first QoE measurement configuration information for a QoE measurement configured by a source SN for a UE from the SN; transmitting the first QoE measurement configuration information to a target SN; and receiving delta configuration information of the first QoE measurement configuration information from the target SN.

Some yet other embodiments of the present application provide another method of supporting QoE measurement collection, which may also be performed in a RAN node during SN (or SCG) change procedure, e.g., a target MN or the like. An exemplary method may include: receiving first QoE measurement configuration information for a QoE measurement configured by a source SN from an MN; generating delta configuration information of the first QoE measurement configuration information; and transmitting the delta configuration information of the first QoE measurement configuration information to the MN.

Some detailed embodiments of the present application will be illustrated hereafter in view of some exemplary NR-DC scenarios. Persons skilled in the art should understand that although MNs and SNs (e.g., source SN and/or target SN) in NR-DC are illustrated in the exemplary embodiments, the illustrated technical solution may also be applied to similar RAN nodes and/or similar scenarios and should not be limited to specific apparatuses and scenarios.

Firstly, some embodiments of the present application in the case of SCG failure occurrence are illustrated in the following, which mainly consider Issues 1, e.g., how to handle the available QoE measurement report and on-going QoE measurement by the UE when SCG failure(s) occurs.

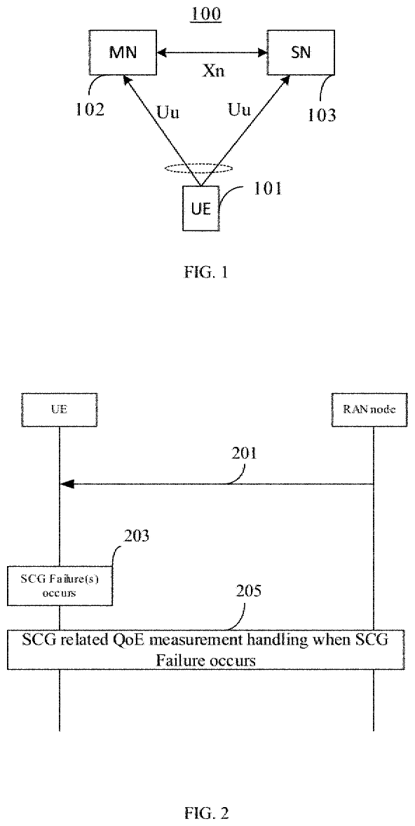

FIG. 2 is a flow chart of an exemplary procedure of supporting QoE measurement collection in the case of SCG failure occurrence according to some embodiments of the present application.

Referring to FIG. 2, in step 201, a RAN node in NR-DC scenarios, e.g., an MN or SN may transmit QoE measurement configuration information (or QoE configuration information) to the remote side, e.g., a UE. The QoE measurement configuration information transmitted to the UE may be referred to as the MN-UE QoE measurement configuration information or MN QoE measurement configuration information or the like in the case of the RAN node served as an MN. The QoE measurement configuration information transmitted to the UE may be referred to as SN-UE QoE measurement configuration information or SN QoE measurement configuration information or the like in the case of the RAN node served as an SN.

The QoE measurement configuration information may indicate one or more QoE measurements, which may be SCG related QoE measurement(s) and/or non-SCG related QoE measurement(s). Herein, only SCG related QoE measurements will be discussed. In addition, for simplification, a single SCG related QoE measurement indicated in the QoE measurement configuration information is illustrated. However, persons skilled in the art would well know how to apply the technical solution disclosed and taught to other SCG related QoE measurement(s) even if there are multiple SCG related QoE measurement(s) indicated in the QoE measurement configuration information.

For example, the RAN node may be an MN. The MN may receive QoE measurement activation information, which is either direct configuration(s) from the OAM (e.g., in the case of management-based QoE measurement), or signalling from the OAM via the CN containing UE-associated QoE configuration (e.g., in the case of signalling-based QoE measurement). For management-based QoE measurement, the MN will select a UE that meet the required QoE measurement after receiving a QoE measurement, and allocate (or assign or configure etc.) a RRC identifier, e.g., measConfigAppLayerId to the QoE measurement, which is used to identify the QoE configuration of the QoE measurement between the MN and the UE, e.g., an application layer measurement configuration (also referred to as a RRC QoE configuration) of the QoE measurement between the MN and the UE. Exemplary MN QoE configuration information for a QoE measurement includes the RRC identifier and application layer measurement container of the QoE measurement. In step 201, the MN will transmit the MN QoE configuration information to the selected UE, e.g., by a RRC signaling (e.g., in AppLayerMeasConfig in a RRCReconfiguration message), e.g., by SRB1 or SRB4.

Similarly, the RAN node may be an SN. The SN may also receive information indicating at least one QoE measurement. For example, the SN may receive QoE measurement activation information from the MN (in the case of signaling-based QoE measurement) or QoE measurement configuration information from the OAM (in the case of management-based QoE measurement). For management-based QoE measurements, the SN may receive the QoE measurement configuration from the OAM as the above illustrated in view of MN, wherein the received QoE measurement configuration may be different from that to the MN or identical with that to the MN. For signaling-based QoE measurements, the MN will receive the QoE measurement activation signalling from the OAM via the CN, and then request the SN to provide QoE measurement configuration to the UE by transmitting the QoE measurement activation information, e.g., in an S-Node Addition Request message or S-Node Modification Request message or the like. Similarly, for management-based QoE measurement, the SN will select a UE that meet the required QoE measurement after receiving the QoE measurement, while independently allocate a RRC identifier to identify the QoE measurement. In step 201, the SN will transmit the QoE measurement configuration information for the QoE measurement to the selected UE, e.g., by a RRC signaling, e.g., by SRB3.

The RAN node, e.g., MN or SN may also determine at least one reporting leg, e.g., MCG and/or SCG to be used for reporting measurement results of the QoE measurement (e.g., QoE measurement report, or QoE measurement reporting or the like). Considering only SCG related QoE measurement is discussed, in the case of the RAN node being an MN, the MN may determine an SCG to be used for reporting the QoE measurement report of the MN configured QoE measurement. In the case of the RAN node being an SN, the SN may determine an MCG and/or an SCG to be used for reporting the QoE measurement report of the SN configured QoE measurement.

In some embodiments of the present application, the RAN node may also determine at least one SRB type used for reporting the QoE measurement report of the QoE measurement. The SRB type can be indicated to the UE separate from the information indicating the determined reporting leg(s) to be used for QoE measurement reporting in the same or different signalings. Considering only SCG related QoE measurement is discussed, either an MN terminated split SRB (e.g., MN terminated split SRB4) or an SN terminated SRB (e.g., SN terminated split SRB4) will be configured for reporting measurement results of MN configured QoE measurement; and either an SN terminated split SRB or an SN terminated SRB (e.g., SRB3) will be configured for reporting measurement results of SN configured QoE measurement. For signaling-based QoE measurements, the MN may also send requested SRB type, e.g., SRB3 for the requested QoE measurement to the SN.

In the UE side, the QoE measurement configuration information will be received accordingly, which at least indicates the QoE measurement and reporting leg used for reporting the measurement results or QoE measurement report of the QoE measurement. The UE will perform QoE measurement collection based on the QoE measurement configuration information. Then, the UE will transmit the QoE measurement report to the RAN node by the configured reporting leg.

However, SCG failure(s) may occur and be detected in step 203, which will cause the configured SCG unavailable (or failed). An exemplary SCG failure may be: radio link failure for the SCG, beam failure of PSCell while the SCG is deactivated, reconfiguration with sync failure of the SCG, SCG configuration failure, or integrity check failure indication from SCG lower layers concerning SRB3 etc. Thus, the UE needs to determine operations on the SCG related QoE measurement in response to the SCG failure. In addition, measurement results, e.g., QoE measurement report of the SCG related QoE measurement may be available at RRC layer of the UE in some cases. For example, an application layer measurement report container has been received from layers upper than the RRC layer when SCG failure(s) happens. The UE also needs to determine how to handle the available QoE measurement report of the QoE measurement. Regarding UE behaviors on handling the SCG related QoE measurement and available QoE measurement report in response to the SCG failure occurring in step 207, some exemplary embodiments of the present application are illustrated in the following.

In some embodiments of the present application, for the SCG related QoE measurement, the UE will switch the reporting leg to MCG from the SCG in response to the SCG failure.

For example, the UE may automatically switch the reporting leg from the SCG to be a predefined MCG. For example, the predefined MCG is the MCG that is serving the UE.

For another example, the UE will switch the reporting leg from the SCG to be a configured MCG. The configured MCG may be configured in the QoE measurement configuration information for the QoE measurement, or in other configuration information for the QoE measurement.

Specifically, according to some embodiments of the present application, in the case that the QoE measurement is configured the MN, the MN will indicate whether the UE needs to switch to the MCG when the SCG is not available. In the case that the MN QoE measurement configuration information for the QoE measurement indicates that the UE needs to switch to an MCG when the SCG is not available, the UE will switch to the MCG in response to SCG failure occurrence.

According to some other embodiments of the present application, in response to SCG failure occurrence, the UE may transmit, to the MN, information indicating that the QoE measurement report (or QoE measurement result) of the QoE measurement is available when SCG failure(s) occurs. For example, the UE may also send a “QoE measurement result available” indication or the like to the MN in SCGFailureInformation message to indicate that QoE measurement result is available when SCG failure(s) occurs. After receiving the indication information reported by the UE, the MN will (re) configure the reporting leg for reporting the QoE measurement report of the QoE measurement to be an MCG, and transmit the configuration information indicating the MCG for the QoE measurement to the UE.

In some scenarios, in the case of switching the reporting leg, the UE will further consider whether SRB4 for transmitting the QoE measurement report of the QoE measurement is configured or not. In the case that SRB4 is configured, the UE will switch the reporting leg to be the MCG from the SCG, wherein, the MCG is predefined or configured in the QoE measurement configuration information as illustrated above. In the case that SRB4 is not configured, the UE will transmit, to the MN, information indicating that QoE measurement report is available when SCG failure occurs, so that the MN will (re) configure the reporting leg for reporting the QoE measurement report of the QoE measurement to be an MCG.

In some other embodiments of the present application, for the SCG related QoE measurement, in response to the SCG failure occurrence, the UE will suspend reporting the QoE measurement report of the SCG related QoE measurement and buffer the QoE measurement report in the case that the QoE measurement report is available in RRC layer, until receiving information indicating another reporting leg, e.g., an MCG or another SCG from the MN.

For example, when SCG failure(s) occurs, the UE may initiate SCG failure information procedure. The UE will suspend the transmission of the QoE measurement report via the unavailable SCG. The UE may also transmit, to the MN, information or indication, e.g., “QoE measurement result available” indication or the like indicating that the QoE measurement report of the QoE measurement is available when SCG failure(s) occurs. After receiving the indication information reported by the UE, the MN will (re) configure the reporting leg and transmit the (re) configured reporting leg to the UE. In the case that the MN decides to switch the reporting leg to be an MCG, the MN will (re) configure an MCG as the reporting leg and transmit the (re) configured MCG to the UE, and then UE will send the buffered or stored QoE measurement report via the MCG to the MN. In the case that, the MN decides to switch the reporting leg to be another SCG (e.g., by SN change procedure), the MN will (re) configure a new SCG as the reporting leg and transmit the new SCG to the UE, and then the UE will send the buffered or stored QoE measurement report via the new SCG.

In some other embodiments of the present application, for SCG related QoE measurement configured by the SN, in response to the SCG failure occurrence, the UE will release the QoE measurement and discard the QoE measurement report in the case that the QoE measurement report is available in RRC layer.

For example, when SCG failure(s) happens and is detected, the AS layer (e.g. RRC layer) of the UE will inform layer(s) upper than the AS layer (e.g. application layer) about the release of the QoE measurement configured by the SN. And the AS layer will discard any application layer measurement reports related to the unavailable SCG, which have not been submitted to lower layers for transmission, e.g., discard any stored segments of segmented RRC messages related to the SCG.

In some yet other embodiments of the present application, for SCG related QoE measurement configured by the SN, in response to the SCG failure occurrence, the UE will pause the QoE measurement. The UE may also suspend reporting the QoE measurement report. After receiving information indicating another reporting leg (new reporting leg), e.g., MCG or another SCG for reporting the QoE measurement report, the UE will resume the QoE measurement and resume reporting the QoE measurement report via the new reporting leg.

For example, when SCG failure(s) happens and is detected, the AS layer (e.g. RRC layer) of the UE will send information or an indication, e.g., SCG failure indication to layer(s) upper than the AS layer, e.g. application layer to inform SCG failure. When the application layer receives the SCG failure indication, the application layer will pause the SCG related QoE measurement configured by the SN. In some scenarios, the layer upper than the AS layer, e.g., the application will be aware whether the SCG related QoE measurement is configured by SN by an explicit indication from the AS layer.

For another example, when SCG failure(s) happens and is detected, the AS layer (e.g. RRC layer) of the UE will send information or indication indicating that the QoE measurement is requested to be paused (e.g., a pause indication) to a layer(s) upper than the AS layer, e.g. application layer. The information indicating that the QoE measurement is requested to be paused may also include a RRC identifier for identifying the QoE measurement requested to be paused. For example, the RRC identifier is measConfigAppLayerId conveyed in the RRC signalling used to identify the application layer measurement configuration and report between the RAN node and the UE. When the application layer receives the pause indication and the RRC identifier, the application layer will pause the QoE measurement identified by the RRC identifier.

In the network side, the RAN node, e.g., the MN or SN may (re) configure a new reporting leg for the SCG related QoE measurement, e.g. configure a new SCG for the QoE measurement, e.g. by SN change procedure. Accordingly, the AS layer will inform the application layer to resume the QoE measurement and resume reporting the QoE measurement report via the new reporting leg.

In some scenarios, to enable reasonable UE battery consumption while having fast usage of SCG when NR-DC is configured, an activation/deactivation mechanism of SCG will be supported for QoE measurement configured by SN. While the SCG is deactivated, there is no transmission via the SCG, that is, the deactivated SCG is unavailable. Thus, Issues 2, e.g., how to handle the available QoE measurement report and on-going QoE measurement by the UE in the case of SCG deactivation need to be solved. Embodiments similar to those for Issues 1, e.g., switching the reporting leg, or suspending reporting the QoE measurement report, or releasing the QoE measurement etc. can also be applied to solve Issues 2 except for the SCG being unavailable due to different SCG event(s).

Briefly, in some embodiments of the present application, the UE may switch the reporting leg to MCG from the deactivated SCG during SCG deactivation. After the SCG is activated, the UE will switch the reporting leg back to the activated SCG.

For example, for the QoE measurement configured by the SN, the UE will determine that the SCG is unavailable in response to the SCG being deactivated, and then switch the reporting leg to be a predefined MCG or a configured MCG from the deactivated SCG. The configured MCG is indicated in the QoE measurement configuration information or in other configuration information. In the case that the configured MCG is configured in the other configuration information, the UE will transmit, to the MN, information indicating that QoE measurement report is available when the SCG is deactivated in response to SCG deactivation while the QoE measurement report for the QoE measurement being available, so as to receive the other configuration information from the MN.

For another example, in response to the SCG being deactivated while the QoE measurement report for the QoE measurement being available, the UE will determine whether SRB4 for reporting the QoE measurement report is configured or not. In the case that SRB4 is configured, the UE will switch the reporting leg to be the MCG from the SCG, wherein, the MCG is predefined or configured in the QoE measurement configuration information. In the case that no SRB4 is configured, the UE will transmit, to the MN, information indicating that QoE measurement report is available when the SCG is deactivated, so as to receive other configuration information indicating the MCG from the MN.

In some other embodiments of the present application, in response to the SCG being deactivated while the QoE measurement report for the QoE measurement being available, the UE may suspend reporting the QoE measurement report and buffer the QoE measurement report available in RRC layer until the SCG is activated.

In some yet other embodiments of the present application, in response to the SCG being deactivated while the QoE measurement report for the QoE measurement being available, the UE may release the QoE measurement and discard the QoE measurement report available in RRC layer.

In some yet other embodiments of the present application, before or when sending SCG deactivation command to the UE, the NW, (e.g., the MN or the SN) will send information or indication indicating that the QoE measurement report is requested to be paused (e.g., a pause indication) to the UE. Accordingly, the UE will pause the QoE measurement and suspend reporting the QoE measurement report via the deactivated SCG. For example, the AS layer of the UE may transmit to a layer upper than the AS layer, e.g., the application layer, information or indication indicating that the SCG is deactivated (e.g., an SCG deactivation indication), and the application layer will pause the QoE measurement requested to be paused. After the SCG is activated, the NW will send information or indication indicating that the QoE measurement report is requested to be resumed (e.g., a resume indication) to the UE. Then, the UE will resume the QoE measurement and resume reporting the QoE measurement report of the QoE measurement via the activated SCG. For example, the AS layer of the UE may indicate to a layer upper than the AS layer, e.g., the application layer to resume the QoE measurement and resume reporting the QoE measurement report.

More details on embodiments in the cases of SCG deactivation will refer to those for cases of SCG failure occurrence and will not repeat herein.

Regarding SCG release, it is usually achieved by SN release procedure. In the case of SCG release, the SCG related configuration is released. However, available QoE measurement related to the SCG, e.g., SN configured QoE measurement may still be useful for the network. Thus, it would be useful to keep the SCG related QoE measurement configured by SN and allow the UE to report the available QoE measurement report to the MN after the SCG is released.

Some embodiments of the present application in the case of SCG release are illustrated in the following, which mainly consider Issues 3, e.g., how to handle the available QoE measurement report and on-going QoE measurement by the UE when SCG is released.

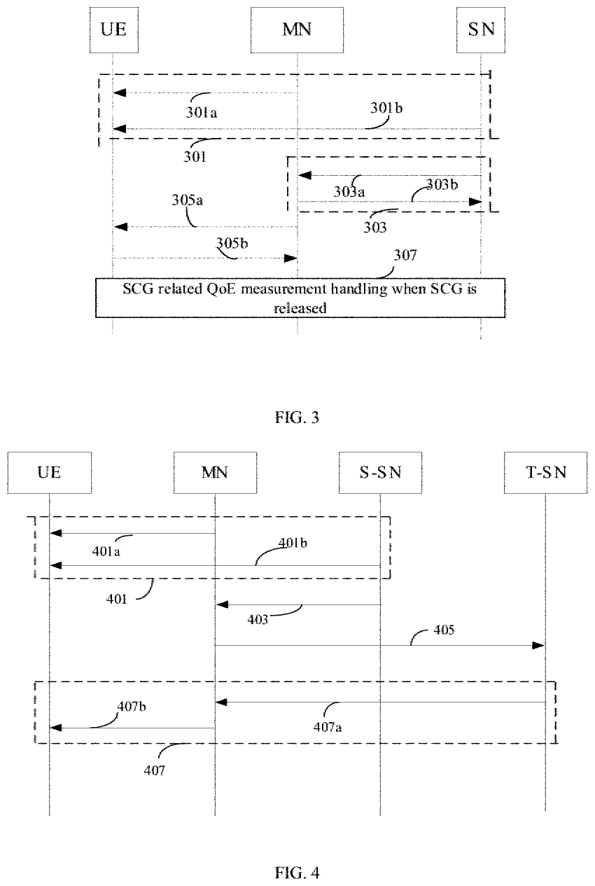

FIG. 3 is a flow chart of an exemplary procedure of supporting QoE measurement collection in the case of SCG being released according to some embodiments of the present application.

Referring to FIG. 3, similar to step 201, a RAN node in NR-DC scenarios, e.g., an MN or SN may transmit QoE measurement configuration information to the remote side, e.g., a UE in step 301. For example, the MN may transmit QoE measurement configuration information to the UE in step 301a, and/or the SN may transmit QoE measurement configuration information to the UE in step 301b. In the illustrated embodiments of FIG. 3, it is assumed that at least SN QoE measurement configuration information for an SN configured QoE measurement will be transmitted to the UE in step 301b.

In the UE side, the QoE measurement configuration information will be received accordingly, which at least indicates the QoE measurement and reporting leg used for reporting the measurement results or QoE measurement report of the QoE measurement. The UE will perform QoE measurement collection based on the QoE measurement configuration information. Then, the UE will transmit the QoE measurement report to the RAN node by the configured reporting leg.

However, SCG release procedure may be performed in step 303. For example, in step 303a, the SN may transmit an SN release request, e.g., by SN Release Required message to the MN. In step 303b, the MN may transmit a response message to confirm the request, e.g., by SN Release Confirm message. The MN may indicate the SN release (or SCG release) to the UE, e.g., by RRC reconfiguration message in step 305a, and the UE may respond to the MN with a RRC reconfiguration complete message in step 305b. In response to the SCG is released, for the QoE measurement configured by the SN, exemplary UE behaviors on handling the QoE measurement configured by SN and available QoE measurement report in step 307 are illustrated in the following.

In some embodiments of the present application, for the SN configured QoE measurement related to the released SCG, the UE will determine whether the QoE measurement will be kept or released based on an indication from the MN. For example, when sending information or indication indicating that the SN or SCG is released to the UE, the MN may also indicate whether the QoE measurement related to the released SN or SCG will be kept or released.

In the case that the MN indicates that the QoE measurement will be kept, the UE will continue the QoE measurement by treating the QoE measurement as MN configured QoE measurement after the SCG is released and changing the reporting leg, e.g., to a predefined reporting leg. In some scenarios, the MN may also explicitly indicate that the reporting leg is changed, e.g., by an additional indication different from that indicating whether the QoE measurement will be kept or released. For example, the additional indication may indicate that the configured reporting leg for the QoE measurement is changed from SCG to MCG. The UE will change the reporting leg according to the additional indication. In the case that the MN indicates that the QoE measurement will be released, the UE will release the QoE measurement and discard the QoE measurement report of the QoE measurement available in RRC layer.

In some scenarios, the UE may not receive any indication indicating the QoE measurement will be kept or not. Then, the UE will release the QoE measurement and discard any available QoE measurement report for the QoE measurement in RRC layer.

As aforementioned, SCG may be changed in some scenarios, which is achieved by SN change procedure. Some embodiments of the present application in the case of SN change are illustrated in the following mainly considering Issues 4, e.g., how to support QoE measurement collection during SN change procedure.

FIG. 4 is a flow chart of an exemplary procedure of supporting QoE measurement collection in the case of SCG change according to some embodiments of the present application.

There are two types of SN change procedure. One is MN initiated SN change procedure (or MN initiated SN change), and the other is SN initiated SN change procedure (e.g., SN initiated SN change). For example, in the case of MN initiated SN change, the MN may trigger the MN-initiated SN Modification procedure, e.g., to the source SN to retrieve the source SCG related QoE measurement configuration information. The source SN will provide the source SCG related QoE measurement configuration information in the SN Modification Request Acknowledge message. In the case of SN initiated SN change procedure, the source SN will provide the source SCG related QoE measurement configuration information in the SN Change Required message. In FIG. 4, embodiments are illustrated only in view of SN initiated SN change procedure. However, persons skilled in the art would well know how to apply the disclosed technical solution to MN initiated SN change procedure under the disclosure and teaching illustrated in the specification.

Referring to FIG. 4, similar to step 201, a RAN node in NR-DC scenarios, e.g., an MN or SN (hereafter, a source SN, or S-SN) may transmit QoE measurement configuration information to the remote side, e.g., a UE in step 401. However, it is assumed that both the MN and source SN can configure QoE measurement(s) independently. For example, the MN can configure a QoE measurement by SRB1, while the source SN can configure a QoE measurement by SRB3. If a QoE measurement is configured by the MN, the MN may transmit MN QoE measurement configuration information to the UE in step 401a. If a QoE measurement is configured by the source SN, the source SN may transmit SN QoE measurement configuration information to the UE in step 401b. In the illustrated embodiments of FIG. 4, at least SN QoE measurement configuration information for a QoE measurement (hereafter, source SCG related QoE measurement configuration information or source SCG related QoE configuration information) will be transmitted to the UE by the source SN in step 401b.

In response to SN change being triggered or initiated, the source SN will provide the source SCG related QoE measurement configuration information to the MN in step 403, e.g., in SN the SN Change Required message. The source SCG related QoE measurement configuration information may include the RRC QoE configuration, e.g. AppLayerMeasConfig configured by the source SN to UE.

In more specific embodiments of the present application, the source SCG related QoE measurement configuration information is provided by scg-CellGroupConfig information element (IE) in the CG-Config IE, which is an IE of inter-node RRC message. An exemplary scg-CellGroupConfig IE is illustrated below.

```
scg-CellGroupConfig
Contains the RRCReconfiguration message (containing only
secondaryCellGroup and/or measConfig and/or otherConfig and/or
conditionalReconfiguration and/or bap-Config and/or
iab-IP-AddressConfigurationList and/or appLayerMeasConfig):
  1>- to be sent to the UE, used upon SCG establishment or modification
    (only when the SCG is not released by the SN), as generated (entirely) by
    the (target) SgNB. In this case, the SN sets the RRCReconfiguration
    message in accordance with clause 6 e.g. regarding the “Need” or
    “Cond” statements.
  2> or
  3>- including the current SCG configuration of the UE, when provided in
    response to a query from MN, or in SN triggered SN change in order to
    enable delta signaling by the target SN. In this case, the SN sets the
    RRCReconfiguration message in accordance with clause 11.2.3.
The field is absent if neither SCG (re)configuration nor SCG configuration
query nor SN triggered SN change is performed, e.g. at inter-node
capability/configuration coordination which does not result in SCG
(re)configuration towards the UE. The field is also absent upon an SCG release
triggered by the SN. This field is not applicable in NE-DC.
```

In step 405, the MN will provide the source SCG related QoE measurement configuration information to a target SN (or T-SN). For example, the MN will include the source SCG related QoE measurement configuration information in SN Addition Request message. In some cases, the MN may also provide the MN QoE measurement configuration information to the target SN in step 405.

In more specific embodiments of the present application, the MN may include the source SCG related QoE measurement configuration information in the sourceConfigSCG IE in the CG-ConfigInfo IE, which is an IE of inter-node RRC message. An exemplary sourceConfigSCG IE is illustrated below. The MN may also include the MN QoE measurement configuration information in a separate IE, e.g. app LayeMeasConfig-MN in the CG-ConfigInfo IE.

sourceConfigSCG
Includes all of the current SCG configurations to be used by the target SN to
build delta configuration to be sent to UE, e.g. during SN change. The field
contains the RRCReconfiguration message, i.e. including secondaryCellGroup
and measConfig, and appLayerMeasConfig. The field is signalled upon change
of SN, unless MN uses full configuration option. Otherwise, the field is absent.

The target SN will use the source SCG related QoE measurement configuration information to generate the delta configuration information for the QoE measurement. Then, the target SN will send the generated delta configuration information to the UE via the MN in step 407. For example, in step 407a, the target SN will send the generated delta configuration information to the MN, e.g., in the SN Addition Request Acknowledge message. The delta configuration information may also be provided by scg-CellGroupConfig IE in the CG-Config IE. In step 407b, the MN will transfer the delta configuration information to the UE, e.g., by MN RRC reconfiguration message including the target SN RRC reconfiguration message. The UE will apply the new QoE measurement configuration information for the QoE measurement configured by the source SN based on the delta configuration.

In addition, persons skilled in the art should well know that although some configurations and/or parameters, e.g., “SN Change Required” etc. are common known in legacy specifications or newly proposed in the specification, they may evolve into other terms as the evolution of 3GPP. Thus, the name of such configurations and/or parameters should not be used to unduly limit the scope of the present application, and should be reasonably interpreted with their technical substance.

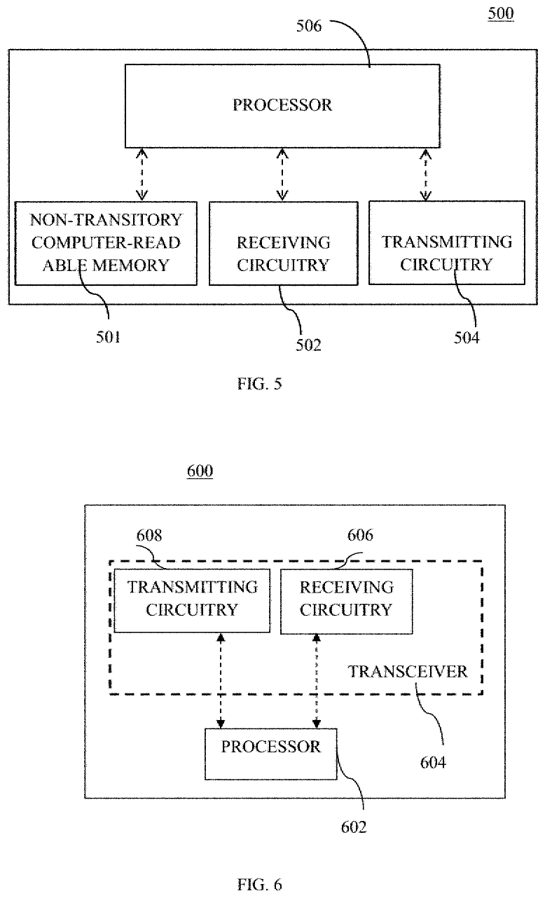

Besides methods, embodiments of the present application also propose an apparatus of supporting QoE measurement collection. For example, FIG. 5 is a block diagram of an apparatus of supporting QoE measurement collection according to some embodiments of the present application.

As shown in FIG. 5, the apparatus 500 may include at least one non-transitory computer-readable medium 501, at least one receiving circuitry 502, at least one transmitting circuitry 504, and at least one processor 506 coupled to the non-transitory computer-readable medium 501, the receiving circuitry 502 and the transmitting circuitry 504. The apparatus 500 may be a RAN node (e.g., an MN, or SN) or a terminal device (e.g., a UE) configured to perform a method illustrated in the above or the like.

Although in this figure, elements such as the at least one processor 506, transmitting circuitry 504, and receiving circuitry 502 are described in the singular, the plural is contemplated unless a limitation to the singular is explicitly stated. In some embodiments of the present application, the receiving circuitry 502 and the transmitting circuitry 504 can be combined into a single device, such as a transceiver. The processor 506 may be a central processing unit (CPU), a digital signaling processing (DSP), a microprocessor etc. In certain embodiments of the present application, the apparatus 500 may further include an input device, a memory, and/or other components.

In some embodiments of the present application, the non-transitory computer-readable medium 501 may have stored thereon computer-executable instructions to cause the processor 506 to implement the method with respect to the RAN node, e.g., an MN or SN as described above. For example, the computer-executable instructions, when executed, cause the processor 506 interacting with receiving circuitry 502 and transmitting circuitry 504, so as to perform the steps with respect to a RAN node as depicted above.

In some embodiments of the present application, the non-transitory computer-readable medium 501 may have stored thereon computer-executable instructions to cause a processor to implement the method with respect to the terminal device as described above. For example, the computer-executable instructions, when executed, cause the processor 506 interacting with receiving circuitry 502 and transmitting circuitry 504, so as to perform the steps with respect to a UE as depicted above.

FIG. 6 illustrates a block diagram of an apparatus 600 of supporting QoE measurement collection according to some other embodiments of the present application.

Referring to FIG. 6, the apparatus 600, e.g., a UE or a RAN node may include at least one processor 602 and at least one transceiver 604. The transceiver 604 may include at least one separate receiving circuitry 606 and transmitting circuitry 608, or at least one integrated receiving circuitry 606 and transmitting circuitry 608. The at least one processor 602 may be a CPU, a DSP, a microprocessor etc.

According to some embodiments of the present application, when the apparatus 600 is a UE, the processor may be configured to: receive QoE measurement configuration information for a QoE measurement, wherein, the QoE measurement is configured by an MN and a reporting leg for QoE measurement report of the QoE measurement is configured to be an SCG, or the QoE measurement is configured by an SN and a reporting leg for QoE measurement report of the QoE measurement is configured to be an MCG or SCG; and determine operations on the QoE measurement in response to the SCG being determined to be unavailable.

According to some embodiments of the present application, when the apparatus 600 is a RAN node, e.g., an MN, the processor is configured to: a transceiver; and a processor coupled to the transceiver, wherein the processor is configured to: receive first QoE measurement configuration information for a QoE measurement configured by a source SN for a UE from the SN; transmit the first QoE measurement configuration information to a target SN; and receive delta configuration information of the first QoE measurement configuration information from the target SN.

According to some other embodiments of the present application, when the apparatus 600 is a RAN node, e.g., a target, the processor is configured to: a transceiver; and a processor coupled to the transceiver, wherein the processor is configured to: receive first QoE measurement configuration information for a QoE measurement configured by an SN from an MN; generate delta configuration information of the first QoE measurement configuration information; and transmit the delta configuration information of the first QoE measurement configuration information to the MN.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE), comprising:
at least one memory; and
at least one processor coupled with the at least one memory and configured to cause the UE to:
receive quality of experience (QoE) measurement configuration information for a QoE measurement, wherein the QoE measurement is configured by a secondary node (SN) and a reporting leg for QoE measurement report of the QoE measurement is configured to be a master cell group (MCG) or a secondary cell group (SCG); and
determine operations on the QoE measurement in response to the SCG being determined to be unavailable.

2. The UE of claim 1, wherein the at least one processor is configured to cause the UE to:
determine that the SCG is unavailable in response to SCG failure occurring; and
switch the reporting leg from the SCG to be a predefined MCG or a configured MCG, wherein the configured MCG is configured in the QoE measurement configuration information or in other configuration information for the QoE measurement.

3. The UE of claim 2, wherein, in response to SCG failure occurring while the QoE measurement report of the QoE measurement being available, the at least one processor is configured to cause the UE to:
transmit, to a master node (MN), information indicating that the QoE measurement report of the QoE measurement is available when SCG failure occurs; and
receive the other configuration information for the QoE measurement from the MN.

4. The UE of claim 2, wherein, in response to SCG failure occurring while the QoE measurement report of the QoE measurement being available, the at least one processor is configured to cause the UE to:
determine whether signaling radio bearer (SRB) 4 for reporting the QoE measurement report is configured or not; and
in response to SRB4 being configured, switch the reporting leg to be the MCG from the SCG, wherein, the MCG is predefined or configured in the QoE measurement configuration information; or
in response to no SRB4 being configured:
transmit, to a master node (MN), information indicating that QoE measurement report is available when SCG failure occurs; and
receive the other configuration information for the QoE measurement from the MN.

5. The UE of claim 1, wherein the at least one processor is configured to cause the UE to:
determine that the SCG is unavailable in response to SCG failure occurring; and
until receiving information indicating another reporting leg from the MN:
suspend reporting the QoE measurement report; and
buffer the QoE measurement report in response to the QoE measurement report being available in radio resource control (RRC) layer.

6. The UE of claim 1, wherein, in response to the QoE measurement being configured by the SN, the at least one processor is configured to cause the UE to:
determine that the SCG is unavailable in response to SCG failure occurring;
release the QoE measurement; and
discard the QoE measurement report in response to the QoE measurement report being available in radio resource control (RRC) layer.

7. The UE of claim 1, wherein, in response to the QoE measurement being configured by the SN, the at least one processor is configured to cause the UE to:
determine that the SCG is unavailable in response to SCG failure occurring;
pause the QoE measurement; and
suspend reporting the QoE measurement report.

8. The UE of claim 1, wherein, in response to the QoE measurement being configured by the SN, the at least one processor is configured to cause the UE to:
determine that the SCG is unavailable in response to that the SCG is released;
determine whether the QoE measurement will be kept or released based on an indication from a master node (MN) the MN; and
in response to the indication indicating that the QoE measurement will be kept, continue the QoE measurement by treating the QoE measurement as MN configured QoE measurement after the SCG is released and changing the reporting leg; or
in response to the indication indicating that the QoE measurement will be released, release the QoE measurement and discard the QoE measurement report.

9. The UE of claim 6, wherein the at least one processor is configured to cause the UE to:
transmit, from an access stratum (AS) layer to a layer upper than the AS layer, information indicating that the QoE measurement is to be released; and
discard any stored segments of segmented RRC messages related with the SCG by the AS layer.

10. The UE of claim 7, wherein the at least one processor is configured to cause the UE to:
receive, from an access stratum (AS) layer by a layer upper than the AS layer, an SCG failure indication; and
pause the QoE measurement by the layer upper than the AS layer.

11. The UE of claim 7, wherein the at least one processor is configured to cause the UE to:
receive, from an access stratum (AS) layer by a layer upper than the AS layer, information indicating that the QoE measurement is requested to be paused and a radio resource control (RRC) identifier identifying the QoE measurement; and
pause the QoE measurement by the layer upper than the AS layer.

12. A radio access network (RAN) node, comprising:
at least one memory; and
at least one processor coupled with the at least one memory and configured to cause the RAN node to:
receive first quality of experience (QoE) measurement configuration information for a QoE measurement configured by a source secondary node (SN) for a user equipment (UE) from the SN;
transmit the first QoE measurement configuration information to a target SN; and
receive delta configuration information of the first QoE measurement configuration information from the target SN.

13. The RAN node of claim 12, wherein the first QoE measurement configuration information is received from the SN in an SN modification request acknowledge message or an SN change required message.

14. The RAN node of claim 12, wherein the at least one processor is configured to cause the RAN node to transmit second QoE measurement configuration information configured by the RAN node to the target SN.

15. A radio access network (RAN) node, comprising:
at least one memory; and
at least one processor coupled with the at least one memory and configured to cause the RAN node to:
receive first quality of experience (QoE) measurement configuration information for a QoE measurement configured by a source secondary node (SN) from a master node (MN);
generate delta configuration information of the first QoE measurement configuration information; and
transmit the delta configuration information of the first QoE measurement configuration information to the MN.

16. The UE of claim 1, wherein, in response to the QoE measurement being configured by the SN, the at least one processor is configured to cause the UE to determine that the SCG is unavailable in response to the SCG being released and release the QoE measurement.

17. The UE of claim 16, wherein the at least one processor is configured to cause the UE to discard any available QoE measurement report for the QoE measurement that is configured to be reported by the SCG in a radio resource control (RRC) layer.

18. A processor for wireless communication, comprising:
at least one controller coupled with at least one memory and configured to cause the processor to:
receive quality of experience (QoE) measurement configuration information for a QoE measurement, wherein the QoE measurement is configured by a secondary node (SN) and a reporting leg for QoE measurement report of the QoE measurement is configured to be a master cell group (MCG) or a secondary cell group (SCG); and
determine operations on the QoE measurement in response to the SCG being determined to be unavailable.

19. The processor of claim 18, wherein the at least one controller is configured to cause the processor to:
determine that the SCG is unavailable in response to SCG failure occurring; and
switch the reporting leg from the SCG to be a predefined MCG or a configured MCG, wherein the configured MCG is configured in the QoE measurement configuration information or in other configuration information for the QoE measurement.

20. The processor of claim 19, wherein, in response to SCG failure occurring while the QoE measurement report of the QoE measurement being available, the at least one controller is configured to cause the processor to:
transmit, to a master node (MN), information indicating that the QoE measurement report of the QoE measurement is available when SCG failure occurs; and
receive the other configuration information for the QoE measurement from the MN.
